(19) United States
(12) Patent Application Publication
(10) Pub. No.: US 2012/0084023 A1
(43) Pub. Date: Apr. 5, 2012

(54) DEVICE FOR DETECTING A WATER LEAK

(76) Inventor: Christian Mavridoglou, Gigean (FR)

(21) Appl. No.: 13/376,823

(22) PCT Filed: Jun. 9, 2010
(86) PCT No.: PCT/FR10/51147

§ 371 Date: Dec. 7, 2011

(30) Foreign Application Priority Data
Jun. 9, 2009 (FR) 09 02772

(51) Int. Cl. G01M 3/28

(52) U.S. Cl. 702/46

(57) ABSTRACT

The invention relates to a device for detecting a water leak in a network, including a water meter, a pulse emitter adapted for transmitting information from the meter to a data processor. The data processor includes at least two pulse meters adapted for operation according to a given flow value of the network and a device for measuring network flow capable of selecting the meter adapted to the measured flow.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention falls within the field of the devices for detecting a leak in a water-supply network.

The invention relates in particular to a device for detecting a water leak in a network, comprising a solenoid valve, a water meter, a pulse emitter designed capable of transmitting information read from said meter to a programmable automate, the latter including a time meter.

The invention also relates to a method for implementing such a device for detecting a leak in a water-supply network.

2. Description of Related Art Including Information Disclosed Under 37 CFR 1.97 and 37 CFR 1.98

In particular from FR 2 573 368 is known a safety device for detecting and limiting the leaks in a duct, comprising two portions, first of all a measuring portion, formed by a volume meter, comprising a paddle wheel and a sensor, placed upstream of the circuit to be protected. The sensor transmits a signal to the second portion of the device when the paddles of the wheel pass in front of it. The second portion is a unit for processing the signal emitted by the sensor and a pulse comparator. Indeed, when the difference between two pulses increases or decreases with respect to a predefined threshold, the device will trigger a timer and a down-counter and, as the case may be, will stop the device by acting on a solenoid valve. This device is also provided with an alarm signal-lamp in order to inform the users of eventual problems.

This device needs, during its operation, to previously know the flow rate of the duct, in order to be capable of setting the threshold, and does therefore not permit a very important change of the latter.

From FR 2 865 804 is also known a device for indicating the level of leaking provided with several timing means installed on a water-supply network. These timing means comprise, for a flow-rate value, a short timing, which can also be referred to as recurring timing, and a long timing, referred to as alarm timing. The short timing permits to repeat the leak, while the long timing permits, in turn, in the event of a repeating of the short timing, to warn about a water leak on the water-supply network after a fixed time period.

Such a device has a first drawback related to the fact that said short and long timings are in the form of meters mounted in series after each other on one and the same network. Therefore, in the event of a high flow rate within said network, all the pairs of timings operate simultaneously, the pairs dedicated to a lower flow rate operating uselessly.

In addition, the timings have fixed values of the flow rate within the network. Therefore, in the event of frequent opening and closing of the taps on the network, as well as of a partial opening of such taps, this produces an false detection of a leak, when there is no such leak.

### SUMMARY OF THE INVENTION

The aim of the present invention is to provide a device for detecting a water leak in a network, which permits to cope with these drawbacks, namely with the mistriggering of these devices of the state of the art.

Thus, the invention relates to a device for detecting a water leak in a network, comprising a water meter, a pulse emitter designed capable of transmitting information read from said meter to data-processing means, wherein said data-processing means include, on the one hand, at least two pulse meters designed capable of operating according to a given network flow-rate value and, on the other hand, means for measuring said network flow-rate capable of permitting to select the meter adapted to the measured flow rate.

According to another feature of the invention, the means for measuring the network flow-rate consist of a time meter designed capable of measuring the time of a pulse of a consumed quantity, whereas said data-processing means consist of means designed capable of selecting the meter depending on this measured time, then of comparing the measured time with a value in memory, which is the time value of the preceding pulse increased with a delta.

According to another feature of the invention, the data-processing means are formed of a programmable automate including at least seven pulse meters each associated to a given network flow-rate value.

The invention also relates to a method for implementing the device, wherein it consists in that:
the time (t) of a pulse corresponding to a consumed quantity is measured;
the meter (11 to 17) corresponding to the value of this time (t) is selected;
this time value (t) is compared with a time value stored in a memory (M10);
either the time value (t) is lower than or equal to this value in memory (M10), and the corresponding meter (11 to 17) is incremented by the consumed quantity and the time value (t) is saved in the memory (M10); or
the time value (t) is higher than this value in memory (M10), and the time value (t) is saved in the memory (M10), which value serves for calculating the reference value at the next measurement of the time (t) of the pulse.

The advantages and features of the device according to the invention will become clear from the following description, which relates to the attached drawing, which represent a non-restrictive embodiment of same.

### BRIEF DESCRIPTION OF THE DRAWINGS

FIG. 1 is a schematic view of an embodiment of the present invention. In the attached drawing, the single figure represents a logical diagram of the device according to the invention.

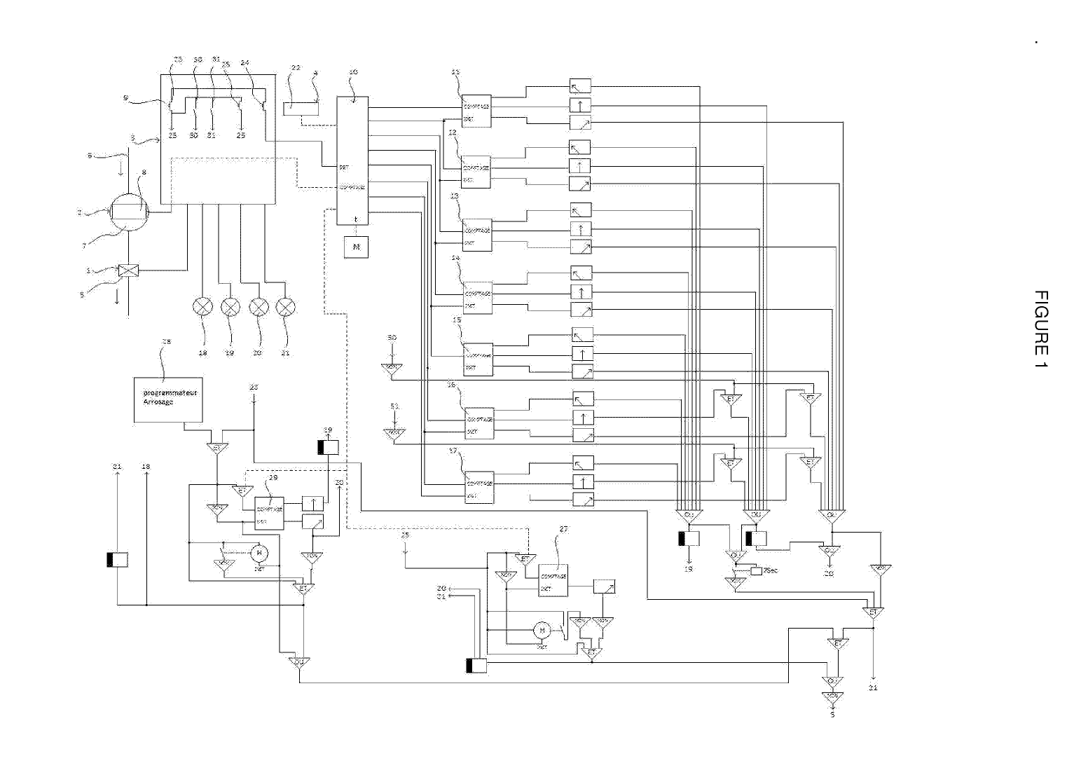

It should be noted that the outputs of the meters are mentioned for the sake of an easy reading of the diagram.

### DETAILED DESCRIPTION OF THE DRAWINGS

The invention will find a particular application in the monitoring of a fluid network, in particular of a domestic water-supply network, at individuals' premises, namely an automatic spraying network.

It thus relates to a device for detecting a water leak, installed upstream of the supply network, as close as possible to the general inlet connection. Such a device includes a means for opening/closing 1 the general flow of said network, means 2 for measuring the flow present (or flowing within the network), means 3 for processing the measured data and means 4 for displaying these data.

The opening/closing means 1 is formed in particular of at least one motorized valve or preferably a solenoid valve 5. This solenoid valve 5 can be installed when mounting the device on a supply network 6.

Advantageously, in the event the water network 6 already has a valve, the device permits to fix on the square element of this valve an adapted motorization permitting to drive same.

According to an embodiment of the de invention, the means 2 for measuring the flow rate of the network 6 are formed of a water meter 7 provided with a flow-meter the needle of which is provided with a target and to which is connected, through adapted means, a pulse emitter 8.

After each consumed liter, the meter 7 transmits a pulse, through the pulse emitter 8, to the data-processing means 3. This transmission can occur through a wire or a radio-link.

Preferably, when the network 6 is already provided with such a water meter 7, the device comprises a connection adapted for fixing the pulse emitter 8 to the water meter 7.

According to a first embodiment, the data-processing means 3 may preferably be formed of a programmable automate 9 or may also be in the form of a programmable locked logical circuit. This programmable automate 9 comprises several inputs and outputs, the latter receiving the pulses emitted from the water meter 7. The automate 9 comprises at least one time meter 10 measuring the time of a pulse, the latter being connected, by its input, to the output of the pulse emitter 8, and by its output to the input of at least two pulse meters 11, 12. Each pulse recorded by the meters 11, 12 is equivalent to one liter of water and, hence, these meters 11, 12 can be considered as volume meters for the water consumed at different flow rates.

The output of these meters 11, 12 is connected to a network of logical gates acting on the solenoid valve 5 or on the display means 4. Each of these meters 11, 12 include three threshold values saved in an own memory M and adjustable by a user or an operator, on the site or remotely.

The thresholds are a leakage threshold S1, an alarm/disconnection threshold S2 warning about an imminent shut-off of the device and a device disconnection threshold S3, which closes the solenoid valve 5, respectively.

According to the invention, the programmable automate includes in particular seven pulse meters 11, 12, 13, 14, 15, 16, 17. Each of these pulse meters 11 to 17 represents a flow rate from the highest to the lowest, respectively, and are selected by the time meter 10 depending on the time value (t) of a pulse. The device can measure very high flow rates, several thousands of liters per hour, as well as very small flow rates in the range of 1 liter per hour.

According to a second embodiment of the invention, the processing means 3 can be formed of a set of electronic cards with a locked program performing the same operations as the programmable automate 9.

According to a particular embodiment, the display means 4 are incorporated in the programmable automate 9 and are in the form of several signal lamps 19, 20, 21 and a LCD display 22 permitting to visualize the various alarms and the state of the device. The signal lamps 19, 20, 21 comprise a leak signal-lamp 19, an alarm/disconnection signal-lamp 20 and a monitoring signal-lamp 21.

The display means 4 preferably also include push-buttons of the type on/off 23, reset 24, and forced operation 25 of the device.

The device can advantageously include a signal lamp 18 for signaling the start of an individual or collective automatic garden spraying cycle.

In particular, the LCD display displays the state of the device depending on the signal lamps 18, 19, 20, 21, which are active.

According to a preferred embodiment of the invention, the display means 4 are offset with respect to the opening/closing means 1, to the measuring means 2 and to the data-processing means 3. In particular, these display means 4 are offset and placed in a technical room easily accessible by the users or the operators in order to permit the latter to be able to proceed to the settings of the device.

Preferably, these display means 4 can be connected remotely to the rest of the device by means of a wired or wireless connection.

When the installation of the device is completed, it is in a shut-off state, the solenoid valve 5 of the device is supplied with current (closed) and thus blocks the passing through of the water in the network 6.

According to a preferred embodiment of the invention, the solenoid valve 5 is normally open (not supplied with current) and it is supplied with current, during a stoppage of a safety shut-off, in order to proceed to its closing.

When the user or the operator presses the on/off push-button, the solenoid valve 5 is no longer supplied with current (open), an indication <<monitoring>> is displayed on the LCD display 22 and a first monitoring signal-lamp 21 is switched on.

The device is then in a normal state of operation.

The water then flows in the network 6 and after each liter of water consumed the water meter 7 sends a pulse, via the pulse emitter 8, to the programmable automate 9, which will process these pulses, interpret them and react depending on the latter.

The pulse arrives in the time meter 10 including a time counting variable (t) T1.

Thus, depending on this time value (t) this meter 10 selects and assigns a liter of water consumed to the corresponding pulse meter 11 to 17. Indeed, the various pulse meters 11 to 17 are adjusted according to this time (t) and thus depending on the flow rate in the network. In particular, each meter (11 to 17) covers a flow-rate range corresponding to a time range (t) in which it is selected by the meter 10 so as to permit a quick and adapted intervention for each flow rate.

Indeed, it should be observed that, in order to avoid the false detections of leaks by the device, the consumed liter is recorded by the meter (11 to 17) only after comparison of the value of T1 with a value stored in memory M10 the programmable automate 9 includes and in which the value T1−1 is recorded.

In short, once the time meter 10 selects the meter (11 to 17) adapted for the flow rate, the value contained in the memory M10, i.e. (T1−1), is compared to the current value of (T1) and, if the latter is lower than or equal to the value in memory M10 plus a delta, namely 30%, the liter is recorded by the selected meter (11 to 17) and the value of T1 is stored in the memory M10.

Otherwise, i.e. when T1 is not included in the interval of memory M10, this value (T1) is stored in M10 without recording the consumed liter, since there was no repetition of the flow rate and the value T1 of the meter 10 is re-initialized.

This value in memory M10 thus acts as a safety margin, which controls the repetition of the flow rate at a close value. In short, the program tolerance interval on this memory M10 with respect to the flow rate permits to accept fluctuations close to the flow rate, namely at plus M10+30%, without re-initializing the meter when the flow rate lies within this safety margin.

More specifically, in the case of a flow-rate drop, but when the latter is not important enough, the meter (11 to 17) will not be re-initialized, although the flow rate is lower than its time interval.

The control of the repetition in addition permits to avoid proceeding to unexpected disconnections due to the repeated opening and closing of taps during the day.

By way of an example is shown the operation of the meter 11, knowing that all the meters 11 to 17 operate according to the same scheme.

The meter 11 is incremented by one liter when the time T1 is included within the time interval that corresponds to the flow rate of this meter. Of course and as we have seen above, it is also necessary that T1 is included within the interval of memory M10. Since the time T1 always remains within the time interval of the meter 11, only the latter is incremented when there exists a repetition of the flow rate.

Thus, as explained above, the first liter is not incremented by the meter, in order to avoid unexpected disconnections. It is indeed necessary that the flow rate is repeated.

When the pulse meter 11 reaches its leakage threshold value S1 stored in the memory M of this meter 11, it triggers, via a first output and a <<OR>> logical gate, the switching-on of the leakage signal-lamp 19 and displays on the LCD display 22 <<leak>> or another message about the state of the device. All the meters 11 to 17 are connected to this <<OR>> gate and thus permit this signal lamp 19 to be switched on when their threshold value S1 is reached.

Preferably, when one of the meters 11 to 17 has reached this value S1 the leakage signal-lamp 19 blinks, in order to indicate that the leak is minimal, the frequency of blinking being proportional to the leak.

If the <<leak>> situation is not solved, the meter 11 can reach the alarm/disconnection threshold S2. If this threshold S1 is reached, the meter 11 will, via a second output and through two <<OR>> gates, cause the alarm/disconnection signal-lamp 20 to blink and display on the LCD 22 the state of the device. This threshold warns the user or the operator about the imminent shut-down of the network supply 6.

Advantageously and after an extended pressing on the on/off button during the putting into service of the device, a partial protection is triggered via the circuit 30 and/or 31 of the latter. this protection permits, namely for the meters 16 and 17, to signal the leaks on the latter, but in no way to proceed to an alarm or a shut-off of the network 6, since the flow rate is very low.

Finally, if the device is not stopped by a user or the problem is not solved, the meter 11 can reach its last threshold value S3, referred to as disconnection threshold. In that case, a third output of the meter 11 will permanently switch on the alarm/disconnection signal-lamp 20 and switch off the monitoring signal-lamp 19. In addition, the solenoid valve 5 is closed, in order to impede the passing through of water and to thus protect the network 6.

The automate 9 stores in its memory the state values of each meter 11 to 17, in order to facilitate the maintenance of the device.

In particular, the programmable automate 9 records:
all the current and maximum values reached by the meters 11 to 17;
the number of disconnections generated by the spraying;
the number of disconnections generated by the flow-rate meters 11 to 17;
the number of spraying starts; and
the number of consumption alarms.

According to an embodiment of the invention, when the flow rate decreases and one passes into a time interval measured by the meter 10 that is higher than the time interval at the meter 11, the meter 12 is selected and the meter 11 is re-initialized 11. One thus understands very well that during a progressive slowing down of the flow rate, even a shut-off of the network supply 6, a resetting in cascade of the pulse meters 11 to 17 is performed.

Of course, as explained above, the meter 11 is reset only when the flow-rate value has dropped enough, i.e. when it is higher than the memory M10 plus the set interval, namely 30%.

By contrast, when the flow rate increases, the pulse meters 11 to 17 will not be re-initialized.

The device advantageously permits, through pressing the RESET button, to initialize the meters 11 to 17 and to switch off the signal-lamps 19, 20.

According to a particular embodiment of the device, it permits a forced operation for filling a swimming-pool or the like. This mode of operation is selectable by means of the forced operation button 25 located either on the programmable automate 9 or on the offset casing of the display means 4, the programmable automate 9 comprises furthermore an additional pulse meter 27, referred to as forced operation meter 27.

When pressing this button 25, the user or operator can chose the duration of this forced operation, over a maximum duration of 48 h per slices of 3 h. He can also limit the forced operation by setting a threshold S of a maximum volume to be reached.

Advantageously, in order to indicate that the device is in forced operation, the leak 20 and the alarm/disconnection 21 signal-lamps blink alternately.

In particular, after each consumed liter, the pulse emitted by the water meter 7 arrives directly at the forced-operation pulse meter 27.

When the duration or the threshold S is reached, the forced operation of the device is stopped, the signal-lamps 20, 21 are switched off and the device is reset into the state in which it was before pressing the forced-operation button, i.e. either stopped or in operation or monitoring. If there were a leak in forced operation, its detection is only delayed until passing into monitoring, since the meters 11 to 17 do no longer count the pulses in forced operation, but are not reset.

In an advantageous application, when an automatic spraying apparatus of an individual or a collective building is connected to the device, the operation in automatic spraying mode is signaled by the switching on of the automatic spraying signal-lamp 18 and the blinking of the monitoring signal-lamp 21 during the full duration of the automatic spraying.

In particular, a spraying programmer 28 whatsoever can be connected to the leak-detecting device via two wires, which will simply send a signal at the start of the spraying cycle:. Said spraying programmer sends a spraying cycle start signal to the device.

Advantageously, the device includes an automatic-spray pulse meter. When the first threshold of the meter 29 is exceeded, the signal lamp 19 blinks, in order to warn about a leak. When the second threshold (disconnection threshold) is reached, the alarm/disconnection signal-lamp 20 is switched on and a disconnection on the network 6 is applied through the solenoid valve 5. The device can be reset by pressing on the RESET button.

If no problem is signaled during the automatic spraying, the device passes automatically into monitoring mode of the network 6 at the end of the spraying cycle.

The meters 11 to 17 are preferably de-activated to avoid the unexpected disconnections of the device during the starts of spraying, but are not reset.

According to an optional embodiment, the device can receive the pulses from a second meter reserved for the spraying, in such case the monitoring is more accurate. Indeed, during a spraying start, the device continues to count the pulses on one of the flow-rate meters 11 to 17, but deduces those proceeding from the pulse emitter (spraying meter), and counts those of the spraying on the volume meter 29 provided for the spraying. The leaks are thus monitored on both networks with distinction.

According to yet another embodiment, the device according to the invention permits to localize the areas of the network from which the leak proceeds, i.e. to accurately determine the leaking portion of the piping.

To this end, the system incorporates at least one combination of a meter and an emitter in each area of the network to be monitored.

Turning back to the previously evoked example, it is possible to position such a combination on the network so as to define increasingly more limited and accurate detection areas. In particular, a first combination can define the entirety of the network, a second one positioned downstream can define an inner area, namely the interior of the house, while a third combination, or the differential with the first one, can define the outer area, namely the garden. This also applies to the interior of the area corresponding to the house, per floor or per room, such as the bathroom, the toilets or the kitchen. Other combinations can be contemplated in a similar way for the outer area, in order to define areas corresponding to the automatic or manual spraying or to the water points, tanks or swimming-pool.

In particular, the invention can foresee to calculate the differential existing between at least two successive combinations. To this end, the flow-rate difference between these two combinations is established, in order to obtain a value that, when not equal to zero, shows a leak on the network.

When the value obtained is higher or equal to a fixed threshold, the leak is located between the two combinations. On the other hand, when the calculated value is strictly lower than said threshold, then the leak is located after the combination located most downstream.

The same also applies when a first combination is located at the inflow and its value serves as a reference, from the latter being subtracted the values of several combinations, namely defining areas as described above.

Furthermore, the invention foresees errors in the calculations and the measurements of the various combinations, namely the pulse of the emitters, which can be different depending on the metrological value of each emitter, on the waist or fouling of each one of them. Such errors, even minimal ones in the range of one milliliter, can generate an accumulation over the time, so as to generate a misinterpretation, concluding to a leak within the network when actually there is none.

In order to cope with the drawbacks related to these errors causing an unexpected triggering of the alarm, the invention includes on the programmable automate (?) a meter T9, which, when it arrives at a given maximum value, controls the re-initialization of all the other meters of said combinations.

The invention also relates to a method for implementing the device for detecting a water leak on the water-supply network, wherein it consists in that:
the time (t) of a pulse corresponding to a consumed quantity is measured;
the meter (11 to 17) corresponding to this value of this time (t) is selected;
this time value (t) is compared with a time value stored in a memory (M10);
either the time value (t) is lower than or equal to this value in memory (M10), and the corresponding meter (11 to 17) is incremented with the consumed quantity and the time value (t) is saved in the memory (M10); or
the time value (t) is higher than this value in memory (M10), and the time value (t) is saved in the memory (M10), which serves for calculating the reference value for the next measurement of the pulse time (t).

According to a detail of the method, the time value (t) stored in memory corresponds to the time value (t) of the preceding pulse increased with a predefined delta.

1. Device for detecting a water leak in a network, comprising a water meter, a pulse emitter transmitting information read from said water meter to data-processing means, wherein said data-processing means comprises at least two pulse meters operating according to a given network flow-rate value and means for measuring said network flow-rate permitting to select the meter adapted to the measured flow rate.

2. Device according to claim 1, wherein the means for measuring the network flow-rate comprises a time meter measuring the time of a pulse of a consumed quantity, and wherein said data-processing means further comprises means for selecting the meter depending on this measured time and then comparing said measured time with a value in memory, the value being a time value of a preceding pulse increased with a delta.

3. Device according to claim 1, wherein the data-processing means comprise a programmable automate having at least seven pulse meters, each meter being associated to a given network flow-rate value.

4. Device according to claim 1, wherein the measuring means for measuring the network flow-rate are comprised of a water meter provided with a flow-meter the needle of which is provided with a target and to which is connected, through adapted means, a pulse emitter.

5. Device according to claim 1, further comprising: a connection adapted for fixing the pulse emitter to the water meter.

6. Device according to claim 1, wherein the data-processing means for processing the data can preferably be formed of a programmable automate.

7. Device according to claim 1, wherein the processing means of a set of electronic cards with a locked program performing the same operations as said programmable automate.

8. Device according to claim 7, wherein said at least one combination of a meter and an emitter in each area of the network are monitored.

9. Device according to claim 8, wherein a differential existing between at least two successive combinations is calculated by establishing the flow-rate difference between these two combinations, in order to obtain a value that, when not equal to zero, shows a leak on the network.

10. Method for implementing the device for detecting a water leak according to claim 1, the method comprising the steps of:
measuring a time of a pulse corresponding to a consumed quantity;
selecting a meter corresponding to a value of said time;
comparing said value with a time value stored in a memory;
determining either said value is lower than or equal to said time value in memory, wherein a corresponding meter is incremented with the consumed quantity and said value is saved in the memory; and
determining said value is higher than said time value in memory, said value being saved in the memory serving for calculating a reference value for a next measurement of pulse time.

11. Method according to claim 10, wherein the time value in memory corresponds to a time value of a preceding pulse increased with a predefined delta.
